(19) United States
(12) Patent Application Publication
(10) Pub. No.: US 2008/0048950 A1
(43) Pub. Date: Feb. 28, 2008

(54) LED display system with embedded microprocessors

(76) Inventors: Shuenn-Yuh Lee, Ming-Hsiung (TW); Dung-Han He, Ming-Hsiung (TW); Tai-Lia Wang, Ming-Hsiung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/508,252

(22) Filed: Aug. 23, 2006

(51) Int. Cl. G09G 3/32

(52) U.S. Cl. 345/82

(57) ABSTRACT

An LED display system with embedded microprocessors is disclosed. It includes an image signal source, an image capture controller, a digital multiplexed encoder, a digital multiplexed decoder and a LED display panel. The image signal source provides signals of static or dynamic images. The image capture controller transmits the control signals and image data. The digital multiplexed encoder is for data encoding and debugging. The digital multiplexed decoder is for data decoding to obtain the color signals, which provides LED with curve correction. The LED display panel displays static or dynamic images. The LED display system could transform images stored in the computer into signals for controlling LED brightness so image data can be transmitted to LED display panel and displayed on the LED display panel successfully.

### BACKGROUND

1. Field of Invention

The present invention relates to a type of LED display system with embedded microprocessors. More particularly, the present invention relates to an LED display system which is capable of transforming the static and dynamic images stored in the computer into signals for the LED display system with embedded microprocessors.

2. Description of Related Art

As far as the developments of various next-gen light sources are concerned, Light Emitting Diode (LED) is the most promising one among those recently developed light sources. The variety of LED applications is why it is a very hot area in the industry, for instance, auxiliary lamp, back-light source of LED, and LED displays. The display formed by arrayed LEDs has been utilized in applications such as traffic lights or, over one hundred inch outdoor TV. Numerous and valuable LED applications have been already available in daily life.

The Energy and Resources Laboratories of the Industrial Technology Research Institute (ITRI) executed “LED Traffic Light for Energy-Saving Demonstration Program” proposed by the Bureau of Energy in the Ministry of Economic Affairs. The result of the program shows that after the traditional incandescent lights were replaced by an estimated 208,000 LED traffic lights in the six biggest cities in Taiwan, in addition to better traffic signal visibility and improved traffic safety, an estimation of 100,000,000 kilowatts-hour was saved per year. If all of the 646,000 traffic lights in Taiwan are changed to LED completely, at least 330,000,000 kilowatts-hour of electricity can be saved. Therefore, the high efficiency and great contribution of LED display can be obviously expected.

The well-known color distortion problems in terms of brightness and color uniformity in conventional LED display prevents the displayed color from being identical to the color carried by the signal source. In order to increase the video frame per second (fps) in the process of transforming signal source into Pulse Width Modulation (PWM) signal required by LED, both encoded and decoded signals have to be simplified but the simplification also leads to inevitable distortion on the displayed image.

This invention can avoid the known technical problems by adopting the internationally-standardized encode and decode system combined with LED color correction table and R/G/B (Red/Green/Blue) LED display.

### SUMMARY

It is therefore an objective of the present invention to provide an LED display system transforming the images captured from the signal source into images on the LED display so as to transform the stored static or dynamic images into the images on the LED display.

In accordance with the foregoing and other objectives of the present invention, an LED display system with embedded microprocessors is disclosed. According to a preferred embodiment of this invention, this LED display system includes an image signal source, an image capture controller, a digital multiplexed encoder, a digital multiplexed decoder and an LED display panel.

The image signal source is a personal computer which provides static or dynamic image signals. The image capture controller captures images from the image signal source through the embedded microprocessors which transmits and receives both controlling signal and image signal between the image capture controller and personal computer. The digital multiplexed encoder receives data transmitted from the image capture controller, encodes and debugs data, then stores data in memory. The digital multiplexed decoder receives data transmitted from the digital multiplexed encoder and reads the color signal contained in the data and converts the color signal into PWM signal format by a PWM circuit in order to drive the LED display panel. The LED display utilizes RIG/B (Red/Green/Blue) LEDs. Each R/G/B LED has output with 8-bit resolution to obtain 24-bit true color effect.

In conclusion, the invention allows the static or dynamic images stored in the computer to be converted to PWM signals controlling LED in order to obtain R/G/B LED with true color effect.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 illustrates a schematic diagram of an LED display system with embedded microprocessors of the preferred embodiment of the present s invention;

FIG. 2 illustrates a schematic diagram of a window interface of the preferred embodiment of the present invention;

FIG. 3 illustrates a schematic diagram of an image capture controller of the preferred embodiment of the present invention;

FIG. 4 illustrates a schematic diagram of a digital multiplexed encoder of the preferred embodiment of the present invention;

FIG. 5 illustrates a schematic diagram of a digital multiplexed decoder of the preferred embodiment of the present invention; and

FIG. 6 shows a schematic diagram of an LED display system of another preferred embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

While the specification concludes with claims defining the features of the invention that are regarded as novel, it is believed that the invention will be better understood from a consideration of the following description in conjunction with the figures, in which like reference numerals are carried forward.

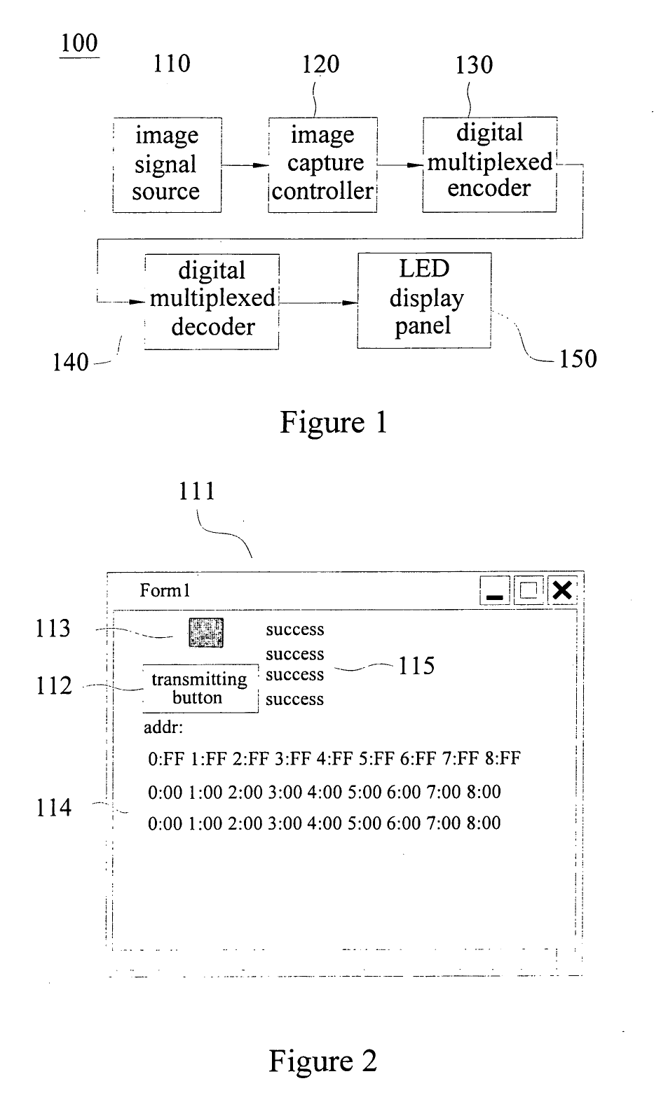

Reference is made to FIG. 1, which illustrates an LED display system with embedded microprocessors of the preferred embodiment of the present invention. LED display system 100 includes image signal source 110, image capture controller 120, digital multiplexed encoder 130, digital multiplexed decoder 140 and LED display panel 150.

Image signal source 110 is a personal computer. Images are captured from the personal computer by a window interface and transmitted to image capture controller 120 through Universal Asynchronous Receiver/Transmitter (UART) interface.

Image capture controller 120 receives image data from personal computer and transforms into data with a serial format ready to be output. The image capture controller 120 comprises embedded microprocessors which not only transfer data from personal computer to the image capture controller 120, but can also be combined with Digital Visual Interface (DVI) to obtain better transmission quality. Besides, additional process can be made to deal with image signals by embedded microprocessors.

The main function of digital multiplexed encoder 130 is to receive image data transmitted from the image capture controller 120 and encode the data into DMX512 format signal. DMX512 is a standard data transmission protocol for light controllers and lamp facilities published by The United States Institute for Theatre Technology (USITT) in 1990.

The main function of the digital multiplexed decoder 140 is to receive signal (image data included) generated by digital multiplexed encoder 130 and decode the data as pulse width modulation (PWM) signals to drive LED display panel 150. Digital multiplexed decoder 140 comprises an LED curve correction table. The pulse width modulation signals can be corrected by the use of the table so the LED display output can be much closer to true color.

LED display panel 150 comprises many R/G/B LEDs. Every R/G/B LED at least includes one red LED, one green LED and one blue LED. The main function of the LED display panel 150 is to let pulse width modulation signals pass through an open collector circuit and transform the voltage into electric current in order to drive the LEDs in LED display panel 150 so images can be displayed properly.

Reference is made to FIG. 2, which illustrates a window interface of the preferred embodiment of the present invention. Window interface 111 includes transmitting button 112, image transmitting display area 113, image data transmitting display area 114 and status of image data transmitting display area 115.

The operating procedure of window interface 111 is to click on the transmitting button 112, and then the image data in the image signal source 110 can be selected and captured by the mouse cursor. After the image data is selected, the image data is shown in the image transmitting display area 113. The image data in the image data transmitting display area 114 are corresponding the image data stored by the image capture controller 120. Status of image transmitting display area 115 displays whether the image data are transmitted successfully or not.

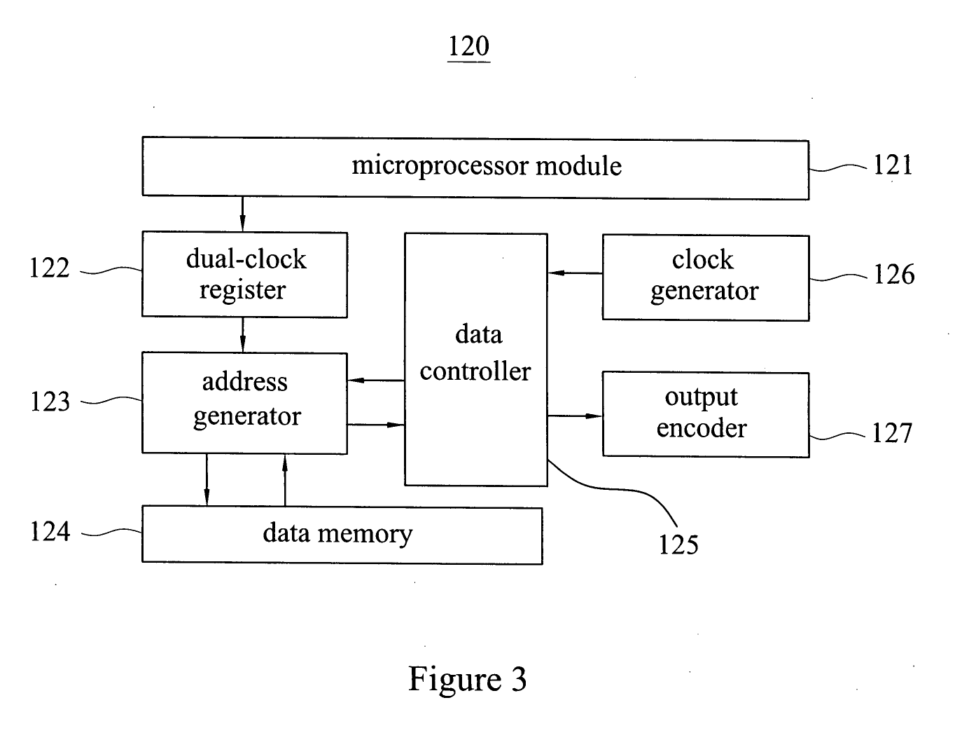

Reference is made to FIG. 3, which illustrates an image capture controller 120 of the preferred embodiment of the present invention. Image capture controller 120 includes microprocessor module 121, dual-clock register 122, address generator 123, data memory 124, data controller 125, clock generator 126 and output encoder 127.

When the image controller 120 is connected with the image signal source 110, microprocessor module 121 will receive the image data transmitted from the image signal source 110 and transmit the image data to dual-clock register 122. Meanwhile, address generator 123 will ask for the image data from dual-clock register 122 repeatedly. As long as there is the image data in the dual-clock register 122, the image data will be transmitted to address generator 123.

However, because the clock in microprocessor module 121 and image capture controller 120 is different (microprocessor module 121 is 11.0592 MHz and image capture controller 120 is 66 MHz), a waveform-shaping circuit is required between microprocessor module 121 and dual-clock register 122. The main function of the waveform-shaping circuit is to modify the width of the signal transmitted from microprocessor module 121 to dual-clock register 122 to fit the system clock width compatible to dual-clock register 122 in order to prevent the data from being misplaced in dual-clock register 122.

Address generator 123 will store the image data in data memory 124. The data memory 124 is divided into two sections in order not to cause image delay in dynamic display. The principle of data memory 124 is when address generator 123 is saving the image data to memory section A, data controller 125 is loading the image data from memory section B. And when address generator 123 is saving the image data to memory section B, the output data become the image data in memory section A for the purpose of displaying dynamic images.

The function of data controller 125 is to control the image data transmitting and the clock generated by clock generator 126. The function of output encoder 127 is to receive the image data loaded by data generator 125 and transform the image data into serial format to be transmitted. Before the data with serial format is transmitted, 7F is added both in the beginning and the ending part of the data as tags for both the beginning and the ending of the data. And 7E is added to the addresses between two sequential 8-bit data to represent the separation of the two data.

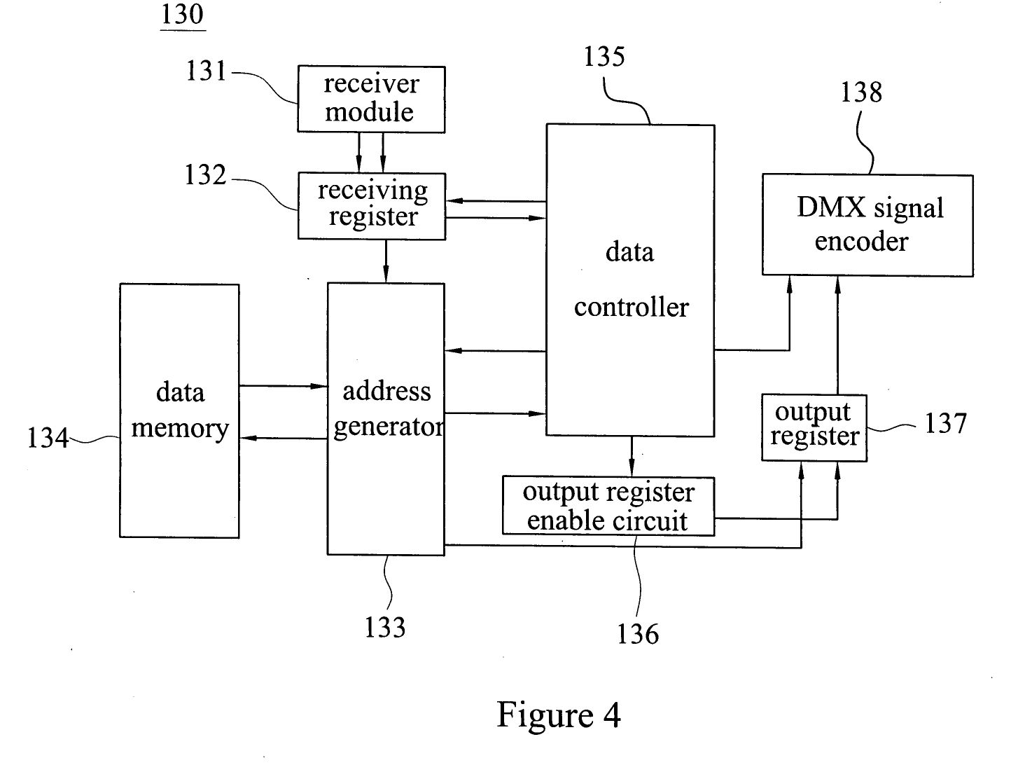

Reference is made to FIG. 4, which illustrates a digital multiplexed encoder 130 of the preferred embodiment of the present invention. Digital multiplexed encoder 130 includes receiver module 131, receiving register 132, address generator 133, data memory 134, data controller 135, output register enable circuit 136, output register 137 and DMX signal encoder 138.

Once if receiver module 131 detects the signal F7, it will start receiving the image data. Each data set is separated by signal 7E. The received image data will be transmitted to receiving register 132 as a first temporary storage. In the meantime address generator 133 will be asking for the image data from receiving register 132. As long as the image data is available in receiving register 132, the image data will be transmitted to address generator 133 and then stored in data memory 134. The function of address generator 133 is to decide whether data memory 134 can be loaded or saved. The address generator 133 outputs the image data as the request of the data controller 135. When the image data are being output, output register enable circuit 136 decides which output register 137 is activated, and the image data are transmitted to DMX signal encoder 138 as an original image data format to be encoded as the DMX512 format.

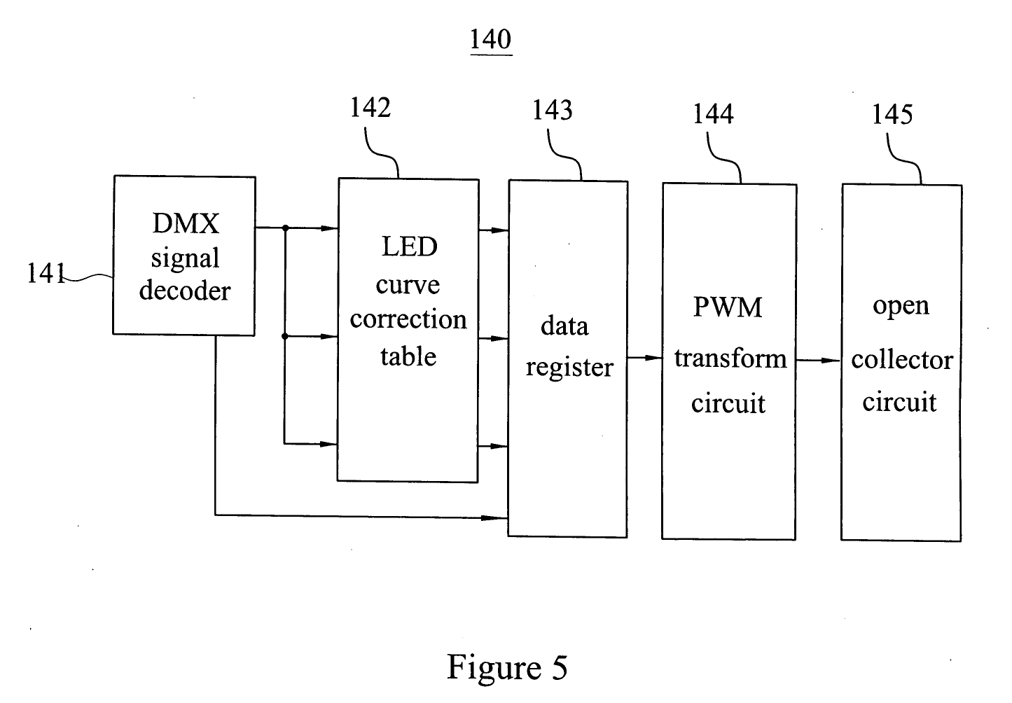

Reference is made to FIG. 5, which shows a digital multiplexed decoder 140 of the preferred embodiment of the present invention. Digital multiplexed decoder 140 includes DMX signal decoder 141, LED curve correction table 142, data register 143, PWM transform circuit 144 and open collector circuit 145.

After DMX signal decoder 141 receives the image data from the digital multiplexed encoder, and then corrected sampled image data by R/G/B LED curve correction table 142 in order to obtain images displayed by the LED closer to true color. As for the output part, the image data transmitted from DMX signal decoder, 141 are saved temporarily in data register 143 and transmitted to PWM transform circuit 144 to transform image signals into data with PWM format. Then open collector circuit 145 transforms the image data as the PWM format into electric current in order to drive the LED display panel 150. Thus, static or dynamic images can be displayed.

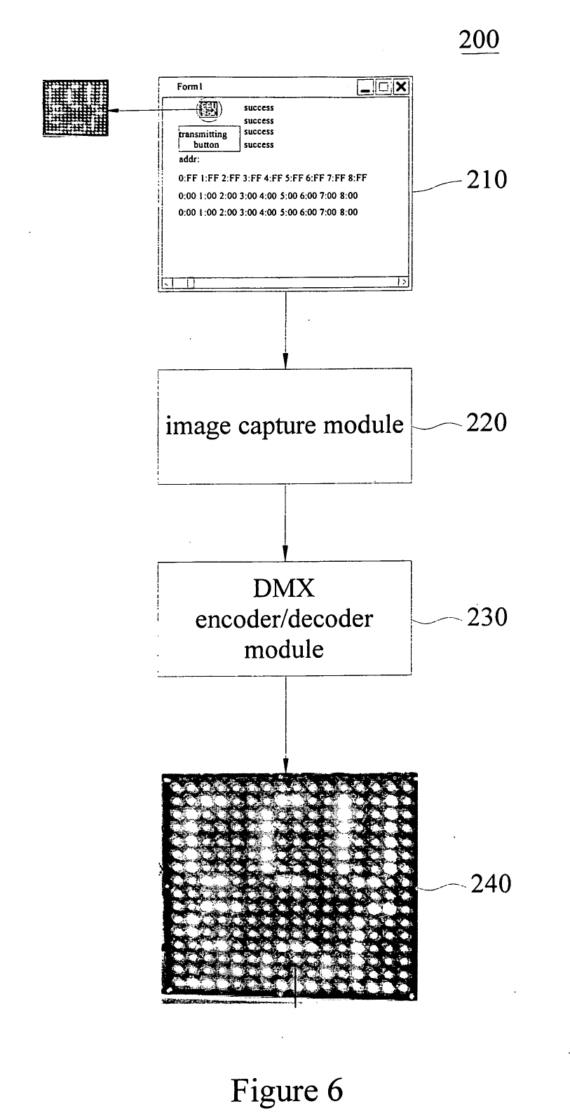

Reference is made to FIG. 6, which shows an LED display system of another preferred embodiment of the present invention. LED display system 200 includes window interface 210, image capture module 220, DMX encoder/decoder module 230 and LED display panel 240.

After window interface 210 captures the images to be output, the image is transmitted to image capture module 220 via transceiver interface, such as RS232 bus, USB bus, IEEE 1394 bus, and DVI interface. Then the image data are processed by DMX encoder/decoder module 230, transmitted to LED display panel 240 and then displayed on LED display panel 240.

According to the preferred embodiments above, there are many advantages of the present invention as following:

1. Static or dynamic images on a personal computer can be shown on LED display system with 24 bit true color effect so image distortion can be greatly reduced.

2. The encode and decode system adopted by this invention uses DMX512 format which is internationally standardized. Therefore, the present invention can be used in a lot of lightening and display applications.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An LED display system with embedded microprocessors, comprising:
an image signal source, comprising a window interface for choosing an image data through the window interface;
an image capture controller, comprising an embedded microprocessor, the image capture controller receiving and transmitting the image data chosen by the window interface;
a digital multiplexed encoder, encoding the image data transmitted from the image capture controller as a DMX512 format signal;
a digital multiplexed decoder, decoding the image data encoded by the digital multiplexed encoder as the DMX512 format signal and transforming it into a pulse width modulation (PWM) format signal; and
an LED display panel, the LED display panel receiving the PWM format Is signal and transforming received the PWM format signal to display the image data chosen by the window interface.

2. The LED display system with embedded microprocessors of claim 1, wherein the image signal source is a personal computer (PC).

3. The LED display system with embedded microprocessors of claim 1, wherein the window interface comprises:
a transmitting button, for selecting and capturing the image data in the image signal source;
an image transmitting display area, showing the image data selected and captured by the transmitting button;
an image data transmitting display area, showing the image data; and
a status of image transmitting display area, displaying whether the image data are transmitted.

4. The LED display system with embedded microprocessors of claim 1, wherein the image is a static image.

5. The LED display system with embedded microprocessors of claim 1, wherein the image is a dynamic image.

6. The LED display system with embedded microprocessors of claim 1, wherein the image capture controller comprises:
a microprocessor module, receiving the image data transmitted from the image signal source and outputting the image data;
a dual-clock register, receiving the image data outputted from the microprocessor module;
an address generator, asking for the image data from the dual-clock register;
a data memory, comprising two sections in order not to cause image delay in dynamic display, and storing the image data from the address generator;
a clock generator, generating a clock;
a data controller, controlling the image data transmitted by the address generator and the clock generated by the clock generator; and
an output encoder, receiving the image data loaded by the data controller and transforming the image data into serial format to be transmitted.

7. The LED display system with embedded microprocessors of claim 6, wherein the microprocessor module connects with Digital Visual Interface (DVI).

8. The LED display system with embedded microprocessors of claim 1, wherein the digital multiplexed encoder comprises:
a receiver module, receiving the image data from the image capture controller;
a receiving register, receiving the image data from the receiver module as a first temporary storage;
an address generator, asking for the image data from the receiving register;
a data memory, storing the image data transmitted by the address generator;
a data controller, requesting the image data from the address generator;
an output register enable circuit, deciding which output register is activated;
a output register, activating by the output register enable circuit and outputting the image data; and
a DMX signal encoder, receiving the image data from the output register as an original image data format and encoding the original image data as the DMX512 format.

9. The LED display system with embedded microprocessors of claim 1, wherein the digital multiplexed decoder comprises:
a DMX signal decoder, receiving the image data from the digital multiplexed encoder and decoding the image data as the original image data format;
a LED curve correction table, correcting the image data from the DMX signal decoder;
a data register, saving the image data transmitted from the DMX signal decoder;
a PWM transform circuit, transforming the image data as the original image data format into the PWM format; and
an open collector circuit, transforming the image data as the PWM format into electric current in order to drive the LED display panel.

10. The LED display system with embedded microprocessors of claim 1, wherein the LED display panel comprises a plurality of R/G/B (Red/Green/Blue) LEDs.

11. The LED display system with embedded microprocessors of claim 10, wherein each of the plurality of R/G/B (Red/Green/Blue) LEDs comprises a red LED.

12. The LED display system with embedded microprocessors of claim 10, wherein each of the plurality of R/G/B (Red/Green/Blue) LEDs comprises a green LED.

13. The LED display system with embedded microprocessors of claim 10, wherein each of the plurality of R/G/B (Red/Green/Blue) LEDs comprises a blue LED.
